(19) United States
(12) Patent Application Publication
(10) Pub. No.: US 2021/0146273 A1
(43) Pub. Date: May 20, 2021

(54) DISTRIBUTOR TRAY FOR A FRACTIONATING COLUMN, COMPRISING A COMPARTMENT FOR DISTRIBUTING GAS

(71) Applicants: IFP Energies nouvelles, Rueil Malmaison (FR); AXENS, Rueil Malmaison (FR); TOTAL SA, Courbevoie (FR)

(72) Inventors: Manel FOURATI, Venissieux (FR); Pascal ALIX, Roussillon (FR); Philippe BEARD, Saint Genis-Laval (FR); Yacine HAROUN, Lyon (FR); Gauthier PERDU, Suresnes (FR); Xavier COURTIAL, Puteaux (FR); Claire WEISS, Vaucresson (FR); Thomas MAUBERT, Pau (FR)

(73) Assignees: IFP Energies nouvelles, Rueil Malmaison (FR); AXENS, Rueil Malmaison (FR); TOTAL SA, Courbevoie (FR)

(21) Appl. No.: 16/625,398

(22) PCT Filed: Jul. 21, 2018
(86) PCT No.: PCT/EP2018/066597

§ 371 Date: Dec. 20, 2019

(30) Foreign Application Priority Data
Jun. 23, 2017 (FR) 1755788

(51) Int. Cl. B01D 3/20; B01D 3/00; B01D 3/24; B01D 53/18; B01D 3/22

(52) U.S. Cl. CPC B01D 3/20; B01D 3/008; B01D 3/24; B01D 2257/504; B01D 3/225; B01D 2252/204; B01D 53/185

(57) ABSTRACT

The present invention relates to a distributor tray (1) comprising chimneys (2) for the passage of gas and means for the passage of liquid. The distributor tray furthermore has at least one casing (10) for distributing the gas. The casing (10) is arranged around a plurality of chimneys (2), and has gas remixing means and gas redistribution means.

The present invention relates to the field of gas/liquid contact columns, and more particularly to offshore columns for gas treatment, CO₂ capturing, dehydration or else distillation.

Units for gas treatment and/or CO₂ capturing by way of amine scrubbing comprise columns for the absorption and regeneration of liquid or gaseous fluids. These operate in countercurrentwise or cocurrentwise gas/liquid flow. When they are offshore, the columns may be installed on boats, floating barges or offshore platforms, for example FPSO (Floating Production, Storage and Offloading) platforms or FLNG (Floating Liquefied Natural Gas) platforms. Distillation columns or dehydration columns may also be installed on floating barges.

The columns that are used in these units (offshore or onshore) for gas treatment and/or CO2 capturing and/or distillation and/or dehydration generally operate on the principle of an exchange of material and/or heat between the gas and the fluid flowing in the columns. Conventionally, this gas treatment column has several sections, each section having a contactor (also called packing), and a collector tray, which is positioned above the contactor. The gas/liquid contactor brings the gas and the liquid into contact in order to allow exchanges of heat and/or material. The tray collects the liquid and allows the liquid to be distributed over the contactor.

The standard onshore distributor trays used in absorption/stripping columns or else distillation columns generally consist of a tray which acts as both a liquid collector and a liquid distributor. The liquid collector for collecting liquid from the contactor immediately above also serves as a gas distributor and a liquid conveyor. The operation of these distributor trays is generally based on gravity. To this end, a liquid guard, the height of which depends on the pressure drop across the tray and the liquid flow rate, is generally formed on the tray so as to provide the hydraulic power necessary for the correct operation of the liquid distributor which consumes pressure energy during the flow.

Several types of gas/liquid distributor tray may be used, and may belong generally to three large families:
Gas-chimney distributors: A liquid guard is established over the entire cross section of the distributor tray, and supplies the contact bed (packing) via orifices that are distributed uniformly over the bottom of the tray. The gas is conveyed via chimneys (e.g. US 2013/0277868A). FIG. 1 shows a conventional distributor tray 1 equipped with chimneys 2 for the passage of the gas, the chimneys being covered by “caps” 3 in order to prevent the passage of liquid within the chimneys in which the gas is flowing (in a countercurrentwise flow situation), and orifices 4 for the passage of liquid.
Liquid-compartment distributors: A liquid guard is established on a set of compartments equipped with supply orfices, and the gas is conveyed via the remaining space (e.g. U.S. Pat. No. 4,909,967A).
Liquid collector-tube distributors: these distributors operate on the same principle as the gas-chimney distributor. The difference is that the liquid is distributed via projecting collector tubes that may have several heights, thus making it possible to convey a wider range of flow rates than in the case of simple orifices drilled into the plate forming the tray bottom. The gas is conveyed thereto via chimneys that may have a cylindrical or parallelepipedal shape (e.g. U.S. Pat. Nos. 5,132,055A, 4,432,913), as in the device of FIG. 1.

One of the designs proposed by those skilled in the art, in particular for columns subject to movements related to swell, consists in collecting the liquid at the axis central to the column in the middle of the collector tray. The collected and centralized liquid is discharged into a vertical sleeve that connects the liquid collector tray and the distribution system via one or more relatively long vertical pipes so that the distributor system remains filled with liquid (said to be “loaded”), regardless of the swell conditions that are encountered. The vertical pipe is dimensioned so that the variation in the liquid height due to a horizontal defect is much less than the height of the liquid pipe supplying the distribution system (U.S. Pat. No. 8,118,284B2, US 2004/0020238 A1). In this case, the liquid distribution system may be formed by one or more sprinklers and the gas is conveyed via chimneys situated on the collector tray.

FIG. 2 shows one example of this type of distributor tray. The distributor tray 1 has chimneys 2 for the passage of gas. The distributor tray 1 has a liquid distribution system, which comprises a vertical pipe 5 and a plurality of sprinklers 6 (horizontal tubes equipped with orifices or nozzles). Other types of distribution system have been developed, in particular spray distribution systems (using nozzles) or trough distribution systems.

For offshore applications, swell movement rapidly degrades the distribution of the liquid and gas phases in the packing beds. This incorrect distribution is more or less significant depending on the type of packing that is chosen, and depending on the periods and the amplitudes associated with the movement of the swell. In any case, it affects the homogeneity of the distribution of the liquid and of the gas in the contact beds, with the creation of areas that are undersupplied with liquid (called “under-wetted”), and areas that are oversupplied with liquid (called “over-wetted”). These incorrect distributions of the liquid lead to incorrect distribution of the gas, again with areas that are oversupplied and undersupplied with gas (in comparison with the average). The distribution of the areas depends on the conditions (column movement, flow rates, contact technology, column size, etc.). The prior art discloses that the drop in efficiency of the packing bed in the column is at a maximum when an area oversupplied with gas encounters an area undersupplied with absorbing liquid, thereby degrading the performance of the columns in question by generating marked concentration profiles.

In the case of gas treatment, the incorrect hydrodynamic distribution of the gas phase and of the liquid phase in a contact bed therefore leads to a more or less efficient absorption of the species to be eliminated in the gas phase via non-homogeneous velocity profiles, but also via non-homogeneous profiles of concentrations of chemical species (for example of H₂S, CO₂) in the two phases. Specifically, the quantity of chemical species transferred between the gas and liquid phases depends in part on the composition of these phases and them being brought into contact, which depends on the contactor and the velocities of the gas and of the liquid. Although the known distributor trays are supposed to redistribute the gas, they are not concerned with remixing it. They do not make it possible to homogenize the concentration profile of chemical species on the cross section of the packing bed.

With regard to this problem, another design proposed by those skilled in the art is to limit the displacement of the liquid on the distributor tray by way of a compartmentalized tray. Such designs are described for example in patent applications FR 2989594 (U.S. Pat. No. 9,120,064), FR 2989595 (U.S. Pat. No. 9,592,468) and FR 3015151 (US 2016/0082364). This design has the advantage of limiting the vertical bulk in comparison with the design illustrated in FIG. 2.

FIG. 3 shows one example of this type of distributor tray. The distributor tray 1 has chimneys for the passage of gas. The distributor tray 1 also has orifices 4 for the passage of liquid. Furthermore, the distributor tray 1 has partitions 7 that define compartments 9. The partitions 7 have orifices 8 allowing the liquid to flow from a compartment 9 to a neighboring compartment. The partitions 7 serve as a barrier to limit the displacement of liquid over the distributor tray 1 about the axis of the column. For offshore applications, the illustrated system uses chimneys that allow the gas to pass through the area of the trays, but does not remix the gaseous phase enough to compensate for the concentration gradients generated in the packing beds that are subjected to swell.

Furthermore, for a given gas processing column design, it seems favorable for the gas to have a concentration that is as homogeneous as possible over the entire cross section in order to achieve the best efficiency and more easily attain the specifications in terms of residual concentrations of H₂S and CO₂ at the column outlet.

Patent application WO 2014/070352 A1 describes a system for mixing gases between two contact beds. The gas mixing system is formed by a plate that creates a restriction in the cross section of a gas passage between two contact beds so as to mix said gas before redistributing it. The gas mixing system described in this patent application is provided below the gas chimneys. This solution thus requires a large space under the distributor tray, even if no liquid distribution system (for example as illustrated in FIG. 2) is used.

Patent application WO 2014/090476 A1 describes a distributor tray equipped with a liquid distribution system and with deflectors for directing the gas. The deflectors are installed around the liquid distribution system. Thus, in order to direct gas, this solution requires a large space under the distributor tray, even if no liquid distribution system (as illustrated in FIG. 2) is used.

To overcome these drawbacks, the present invention relates to a distributor tray comprising chimneys for the passage of gas and means for the passage of liquid. The distributor tray furthermore has at least one casing for distributing the gas. The casing is arranged around a plurality of chimneys, and has gas remixing means and gas redistribution means. The gas passing through the distributor tray is thus mixed and distributed at the outlet of the chimneys for the passage of the gas, thereby allowing the gas phase to be homogenized and correcting the incorrect hydrodynamic distribution of the gas phase. This design does not require any space below the distributor tray, thereby making it possible to adapt to any type of distributor tray, in particular those illustrated in FIGS. 1 to 3.

### The Device According to the Invention

The invention relates to a distributor tray for a column for exchanging heat and/or material between a gas and a liquid, said tray having a plurality of chimneys projecting on the upper part of said tray for the passage of said gas through said tray, and at least one means for the passage of said liquid through said tray. Said tray comprises at least one casing for distributing said gas, said casing being arranged around at least two chimneys for the passage of the gas. Said casing covers at least part of the height of the chimneys, said casing projects above the chimneys, said casing is closed off laterally and open at its upper end and at its lower end, and said casing has means for remixing said gas that are arranged to remix the gas from said at least two chimneys for the passage of the gas, and means for redistributing said gas that are arranged above said means for remixing said gas.

According to one embodiment of the invention, said casing has a substantially parallelepipedal shape.

Advantageously, said casing is arranged around an alignment of chimneys for the passage of said gas.

According to one aspect, said casing is covered by a cap.

According to one implementation, said remixing means have a plate provided with at least one central opening.

As an alternative, said remixing means have at least one baffle.

As a variant, said remixing means have at least one packing, preferably at least one structured packing.

According to one alternative, said remixing means have a network of tubes connecting said chimneys for the passage of said gas.

Advantageously, said means for redistributing said gas have a plate having a plurality of orifices, said orifices preferably being distributed evenly over said plate.

According to one embodiment, said casing is arranged on the upper part of said chimneys for the passage of said gas, said chimneys in particular being covered by said casing over a height less than three quarters of the height of said chimneys for the passage of said gas.

Preferably, said chimneys for the passage of said gas are cylindrical.

According to one feature, at least two of said chimneys for the passage of said gas have different diameters.

According to one implementation, said casing is covered by an inclined or triangular cap for transferring the liquid on both sides of the gas remixing casing.

The invention also relates to a column for exchanging heat and/or material between a gas and a liquid, wherein said two fluids are brought into contact by way of a packing. Said column has at least one distributor tray according to one of the above features for distributing said fluids over said packing.

The invention furthermore relates to the use of a column according to one of the above features for a process for gas treatment, acid gas capturing, distillation, dehydration or air separation.

### BRIEF INTRODUCTION TO THE FIGURES

Other features and advantages of the process according to the invention will become apparent on reading the following description of nonlimiting exemplary embodiments, with reference to the appended figures described below.

FIG. 1, already described, illustrates a distributor tray with chimneys for the passage of gas according to the prior art.

FIG. 2, already described, illustrates a distributor tray with chimneys for the passage of gas and a liquid distribution system, according to the prior art.

FIG. 3, already described, illustrates a distributor tray with chimneys for the passage of gas and perforated partitions, according to the prior art.

FIG. 4 illustrates a distributor tray according to one embodiment of the invention.

FIG. 5 illustrates a casing according to a first embodiment of the invention.

FIG. 6 illustrates a casing according to a second embodiment of the invention.

FIG. 7 illustrates a casing according to a third embodiment of the invention.

FIG. 8 illustrates a casing according to a fourth embodiment of the invention.

### DETAILED DESCRIPTION OF THE INVENTION

The present invention relates to a distributor tray for a column for exchanging heat and/or material between a gas and a liquid, conventionally comprising a plurality of means for the passage of gas through the tray, in this case chimneys projecting on the upper part of the tray, at least one means for the passage of the liquid through the tray. The distributor tray makes it possible to form a liquid guard on its upper surface, that is to say a liquid level situated on the upper face of the tray. The distributor tray according to the invention is designed for countercurrentwise flows in the heat and/or material exchange column, the gas rising through the casings and the liquid descending through the chimneys and the distribution means. The exchanger/distributor tray may conventionally be substantially cylindrical.

The means for the passage of the liquid through the tray may in particular be in accordance with the means for the passage of liquid illustrated in FIGS. 1 to 3; according to a first example, the liquid may pass through the tray by way of orifices formed in the tray; according to a second example, the liquid may pass by way of a liquid distribution system. As an alternative, the liquid may pass by way of liquid passage chimneys.

According to the invention, the distributor tray has at least one casing for the distribution of the gas. The casing is arranged around at least two chimneys for the passage of the gas. The casing is intended to ensure a good distribution of the gas from the chimneys to the packing situated above the distributor tray. The casing covers at least part of the height of the chimneys for the passage of the gas, and projects above the chimneys in order for the gas to pass to an upper contact bed (in other words to an upper packing bed). To this end, the casing is closed off laterally, and is open at its upper and lower ends. At the lower end, the casing is open for the passage of the gas chimneys (intake of gas into the casing). At the upper end, the casing is open for the distribution of the gas (evacuation of gas from the casing), this upper opening may consist of the entire cross section of the casing.

The casing has gas remixing means, able to mix the gas from the various chimneys. The casing furthermore has gas redistribution means in order to achieve a homogeneous distribution of the gas over the packing. The gas remixing means are situated above the chimneys, and the gas redistribution means are situated above the gas remixing means. The gas thus passes through the tray and is then remixed before being distributed.

The casing allows a homogeneous distribution of the gas over the packing of the contact bed situated above the distributor tray, and makes it possible to avoid incorrect distribution of the gas in the packing situated above the distributor tray. This design therefore allows remixing of the gas above the distributor tray, thereby making it possible to limit the space requirement below the distributor tray. In addition, this design is compatible with any type of distributor tray, in particular with the distributor trays of FIGS. 1 to 3 (with or without a liquid distribution system).

According to one embodiment option, the distributor tray may have a plurality of casings for the distribution of gas. Each chimney for the passage of the gas may thus terminate in a casing for the distribution of the gas, thereby making it possible to ensure mixing over the entire cross section of the column, in order to homogenize the distribution of the gas.

According to one implementation of the invention, the casings may have a substantially parallelepipedal shape. This shape makes it possible to limit pressure losses. This shape makes it possible to install a limited number of casings gathering the gas coming from a plurality of chimneys. Other casing shapes may however be used, for example cylindrical, prismatic or hexahedral, etc. casings.

According to one feature of the invention, the casings may be arranged around an alignment of chimneys for the passage of the gas. Each casing is thus arranged around a plurality of aligned chimneys for the passage of the gas. The design of the casing is thus simplified. As an alternative, the casings may be arranged around non-aligned chimneys. For example, the casing may have a square cross section and be arranged around chimneys that are distributed over several rows.

In order to prevent the liquid from falling into the casings (case of the countercurrentwise gas/liquid flow) and a fortiori into the chimneys, the casings may be equipped with caps situated at a certain height above the casings.

In one embodiment of the invention, caps are inclined so as to allow the liquid to flow on either side of the gas remixing casing to the liquid reception area situated under the gas remixing casing.

According to one embodiment of the invention, the casings may be arranged in the upper part of the chimneys. The liquid guard on the distributor tray is thus not disturbed by the presence of the casings. The chimneys may preferably be covered by the casing over a height of less than half the height of the chimneys for the passage of the gas. The casings may be attached directly to the chimneys for the passage of the gas.

According to one embodiment option, the casings may have a height of between 200 and 400 mm, in order to ensure remixing of the gases and to limit the size of the column.

According to one implementation of the invention, it is also possible to leave free space between the casings and the chimney tops. This space may possibly be occupied by the liquid. It is thus possible to maintain a wide liquid guard range above the distributor tray, and a fortiori keep a wide operating range of the distributor in terms of liquid and gas flow rates.

The chimneys for the passage of the gas may have a cylindrical, parallelepipedal, prismatic or similar shape. In the case of cylindrical chimneys for the passage of the gas, these may have different diameters, and in this case a casing may group together the gas from chimneys of different diameters.

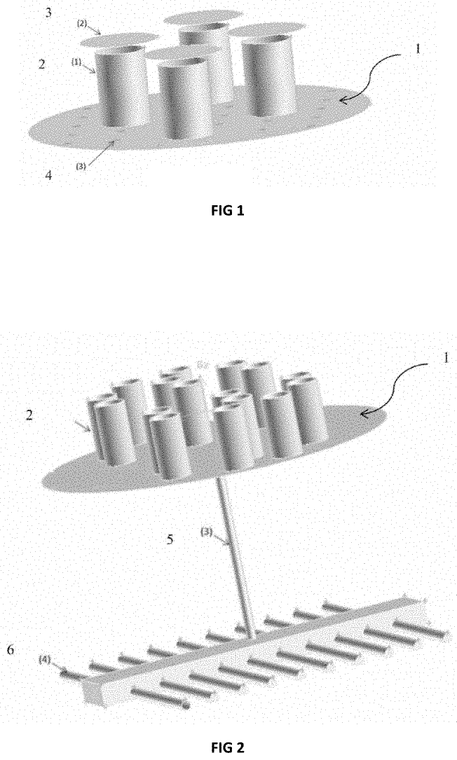

The means for the passage of the liquid allow the liquid to pass from the top of the tray to the bottom. According to one embodiment of the invention, the means for the passage of the liquid through the tray may be formed of a set of tubes that may project from the upper side of the tray and/or from the lower side of the tray. The chimneys may be substantially cylindrical. According to another embodiment of the invention, the means for the passage of the liquid through the tray may be formed of a set of orifices produced in the tray. According to another exemplary embodiment of the invention, the means for the passage of the liquid through the tray may have both chimneys and orifices. These means for the passage of the liquid are arranged between the chimneys for the passage of the gas. The number of means for the passage of the liquid is advantageously greater than the number of chimneys for the passage of the gas. The means for the passage of the liquid may be distributed evenly. In this case, the distribution path of the means for the passage of the liquid may be triangular or square. As an alternative, the means for the passage of the liquid may be distributed irregularly and/or be of different size. In order to achieve a good distribution of the liquid and a good distribution of the liquid over the contactor (packing), the means for the passage of the liquid are preferably distributed uniformly over the tray, that is to say situated on the whole of the surface of the tray, between the chimneys for the passage of the gas. According to another exemplary embodiment, the tray may also comprise a liquid distribution system as illustrated in FIG. 2.

The means for remixing the gas contained in the gas distribution casings may take several forms.

According to a first embodiment of the invention, the gas remixing means may be formed by a substantially horizontal plate provided with at least one central opening. The flow of the gas flowing in the casing is thus directed into this single central opening, thereby causing the gas to remix. The central opening may have any shape: circular, rectangular, elliptical, etc.

According to a second embodiment of the invention, the gas remixing means may be formed by way of at least one baffle, the baffle being able to be formed by at least two substantially horizontal plates. The flow of the gas flowing in the casing is thus directed into the baffles, thereby causing remixing.

According to a third embodiment of the invention, the remixing means may be formed by a packing, preferably a structured packing. The remixing is thus performed by the packing.

According to a fourth embodiment of the invention, the remixing means may be formed by a network of tubes that connect all of the chimneys within one casing. The network of tubes may comprise horizontal tubes that connect the chimneys for the passage of the gas, and one or more substantially vertical orifices for releasing the gas. The orifice for releasing the gas may advantageously be located in the center of the casing. The remixing is then performed within this network of tubes.

Other embodiments may be contemplated.

The gas redistribution means may take several forms.

According to a first embodiment of the invention, the gas redistribution means may be formed by a substantially horizontal plate that has a plurality of orifices. This embodiment has the advantage of being easy to implement. In order to allow a homogeneous distribution, the orifices may be distributed evenly over the entire length of the plate.

According to a second embodiment of the invention, the gas redistribution means may be formed by a pipe having a plurality of orfices.

Other embodiments may be contemplated.

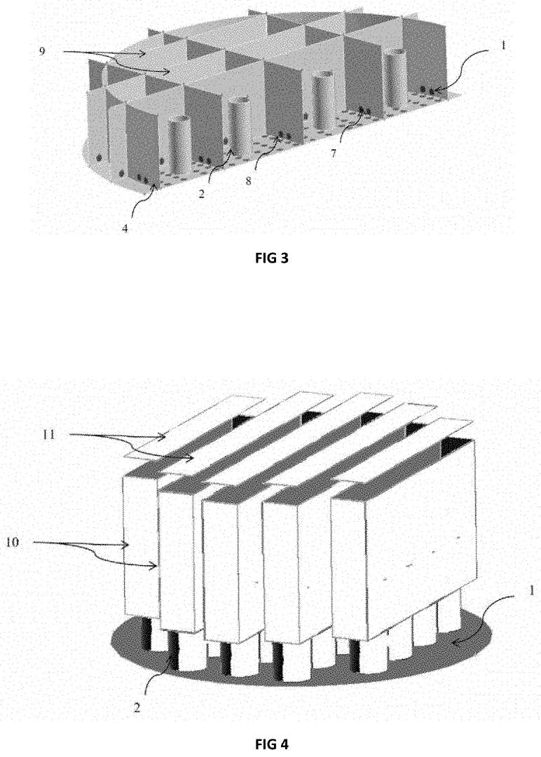

FIG. 4 schematically and nonlimitingly illustrates a distributor tray according to one embodiment of the invention. In this figure, the means for the passage of the liquid are not shown, but they may in particular correspond to the orifices produced in the tray as illustrated in FIGS. 1 and 3 or to the liquid distribution system as illustrated in FIG. 2, or to chimneys for the passage of the liquid. The distributor tray 1 has a plurality of chimneys 2 for the passage of the gas. Casings 10 for the distribution of the gas are arranged in the upper part of the chimneys. The casings 10 are arranged above a plurality of aligned chimneys 2. Furthermore, a cap 11 is provided above each casing 10 in order to prevent the introduction of liquid into the casings 10 and the chimneys 2. The casings 10 have a substantially parallelepipedal shape.

FIG. 5 schematically and nonlimitingly illustrates a gas distribution casing according to a first embodiment of the invention. The casing 10 that is illustrated is arranged around four chimneys 2 for the passage of the gas, the chimneys 2 being aligned. The casing 10 may be similar to that of FIG. 4. The casing 10 has a substantially parallelepipedal shape. From the bottom upward, the casing 10 has an area covering the chimneys 2 (corresponding to the upper part of the chimneys), gas remixing means 12, gas distribution means 13, an opening and a cap 11. For the embodiment of FIG. 5, the gas remixing means 12 are formed by a substantially horizontal plate 14 having a central opening 15, and the gas distribution means 13 are formed by a substantially horizontal perforated plate 16. The perforated plate 16 has a plurality of orifices that are possibly distributed evenly. The gas thus passes through the tray (not shown) via the chimneys 2, and is then directed to the center of the casing 10 by the plate 14 and the central opening 15, and then passes through the orifices in the perforated plate 16, before leaving the casing 10 via its upper opening.

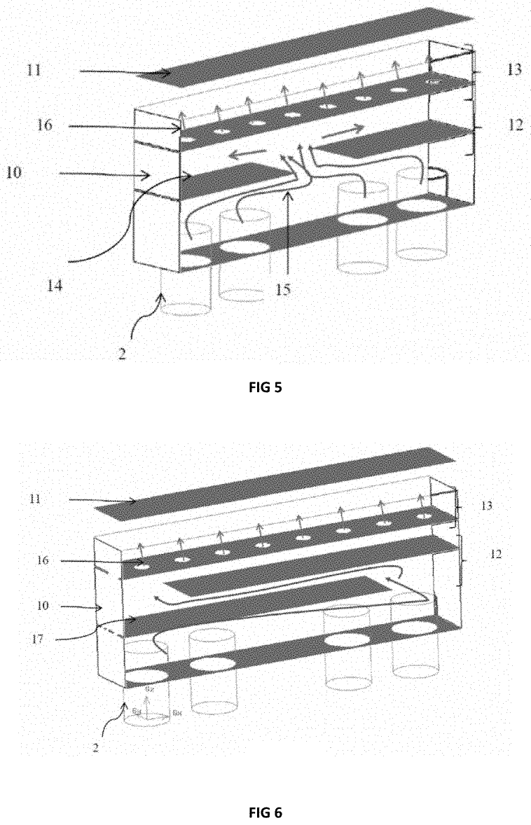

FIG. 6 schematically and nonlimitingly illustrates a gas distribution casing according to a second embodiment of the invention. The casing 10 that is illustrated is arranged around four chimneys 2 for the passage of the gas, the chimneys 2 being aligned. The casing 10 may be similar to that of FIG. 4. The casing 10 has a substantially parallelepipedal shape. From the bottom upward, the casing 10 has an area covering the chimneys 2 (corresponding to the upper part of the chimneys), gas remixing means 12, gas distribution means 13, an opening and a cap 11. For the embodiment of FIG. 6, the gas remixing means 12 are formed by two baffles 17 made from two substantially horizontal plates, and the gas distribution means 13 are formed by a substantially horizontal perforated plate 16. The perforated plate 16 has a plurality of orifices that are possibly distributed evenly. The gas thus passes through the tray (not shown) via the chimneys 2, and is then directed from a first end of the casing 10 to a second end of the casing 10 by the baffles 17, and then passes through the orifices in the perforated plate 16, before leaving the casing 10 via its upper opening.

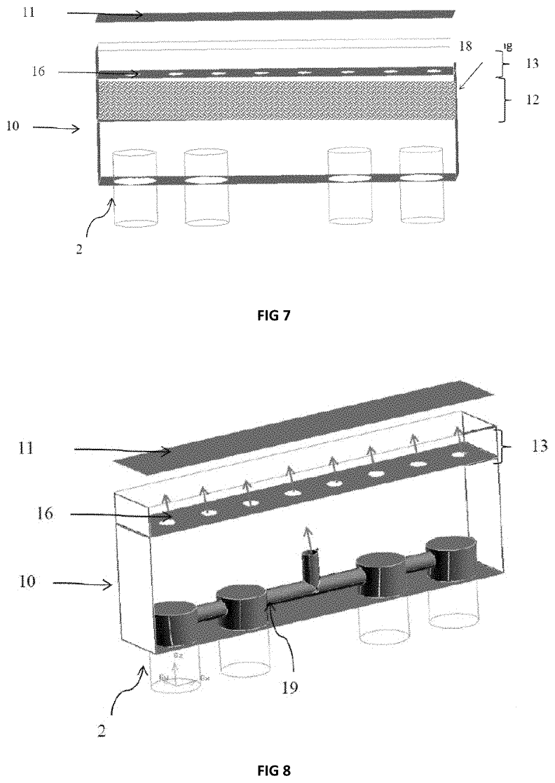

FIG. 7 schematically and nonlimitingly illustrates a gas distribution casing according to a third embodiment of the invention. The casing 10 that is illustrated is arranged around four chimneys 2 for the passage of the gas, the chimneys 2 being aligned. The casing 10 may be similar to that of FIG. 4. The casing 10 has a substantially parallelepipedal shape. From the bottom upward, the casing 10 has an area covering the chimneys 2 (corresponding to the upper part of the chimneys), gas remixing means 12, gas distribution means 13, an opening and a cap 11. For the embodiment of FIG. 7, the gas remixing means 12 are formed by a packing 18 (for example structured packing) positioned substantially horizontally, and the gas distribution means 13 are formed by a substantially horizontal perforated plate 16. The perforated plate 16 has a plurality of orifices that are possibly distributed evenly. The gas thus passes through the tray (not shown) via the chimneys 2, and is then directed through the packing 18, in which it is remixed, and then passes through the orifices in the perforated plate 16, before leaving the casing 10 via its upper opening.

According to one embodiment of the invention, the packing 18 may be loose packing, because it is easier to install in the casing.

According to one embodiment of the invention, the packing 18 may be a metal fabric (lattice), because it is easier to install in the casing.

FIG. 8 schematically and nonlimitingly illustrates a gas distribution casing according to a fourth embodiment of the invention. The com casing 10 that is illustrated is arranged around four chimneys 2 for the passage of the gas, the chimneys 2 being aligned. The casing 10 may be similar to that of FIG. 4. The casing 10 has a substantially parallelepipedal shape. From the bottom upward, the casing 10 has an area covering the chimneys 2 (corresponding to the upper part of the chimneys), gas remixing means, gas distribution means 13, an opening and a cap 11. For the embodiment of FIG. 8, the gas remixing means are formed by a network of tubes 19, and the gas distribution means 13 are formed by a substantially horizontal perforated plate 16. The network of tubes 19 has substantially horizontal tubes that connect all of the chimneys 2 within the casing 10, and has an open tube for evacuating the gas; the open tube is positioned substantially vertically in the center of the casing. The perforated plate 16 has a plurality of orifices that are possibly distributed evenly. The gas thus passes through the tray (not shown) via the chimneys 2, and is then directed through the network of tubes 19, in which it is remixed, and then passes through the orifices in the perforated plate 16, before leaving the casing 10 via its upper opening. Implementing the network of horizontal tubes in FIG. 8 makes it possible to reduce the height of the remixing casing compared to the devices in FIGS. 5, 6 and 7.

The invention also relates to a column for exchanging material and/or heat between two fluids, in which two fluids are brought into contact by way of at least one gas/liquid contactor, the column comprising at least one first inlet for a liquid fluid, at least one second inlet for a gaseous fluid, at least one first outlet for a gaseous fluid and at least one second outlet for a liquid fluid. The column furthermore has at least one exchanger/distributor tray as described above in order to allow fluids to be distributed over the contactor.

The column preferably has a plurality of sections comprising a contactor, a distributor tray as described above being arranged in each section.

As the useful height of each tray also contributes to the exchange of heat and/or material, in addition to the exchanges performed in the contactor, the exchange column does not have a “height loss” in terms of the efficiency of the column. A column containing such a distributor tray may therefore be lower, thereby allowing a smaller bulk and a reduction in the cost of the column.

Advantageously, the gas/liquid contactor is a structured packing bed. As an alternative, the gas/liquid contactor is a loose packing bed.

The gas and the liquid preferably flow countercurrentwise in the column.

The column according to the invention may be used in processes for gas treatment, CO₂ capturing (for example by amine scrubbing), distillation, dehydration, or air transformation, etc. The invention may also be used with any type of solvent.

1) A distributor tray for a column for exchanging heat and/or material between a gas and a liquid, said tray (1) having a plurality of chimneys (2) projecting on the upper part of said tray (1) for the passage of said gas through said tray (1), and at least one means for the passage of said liquid (4; 5) through said tray (1), characterized in that said tray (1) has at least one casing (10) for distributing said gas, said casing (10) covering at least part of the height of the chimneys (2), said casing (10) projecting above the chimneys (2), said casing (10) being closed off laterally and open at its upper end and at its lower end, said casing (10) being arranged around at least two chimneys (2) for the passage of the gas, said casing (10) having means (12) for remixing said gas that are arranged to remix the gas from said at least two chimneys (2) for the passage of the gas, and means (13) for redistributing said gas that are arranged above said means (12) for remixing said gas.

2) The tray as claimed in claim 1, wherein said casing (10) has a substantially parallelepipedal shape.

3) The tray as claimed in claim 1, wherein said casing (10) is arranged around an alignment of chimneys (2) for the passage of said gas.

4) The tray as claimed in claim 1, wherein said casing (10) is covered by a cap (11).

5) The tray as claimed in claim 1, wherein said remixing means (12) have a plate (14) provided with at least one central opening (15).

6) The tray as claimed in claim 1, wherein said remixing means (12) have at least one baffle (17).

7) The tray as claimed in claim 1, wherein said remixing means (12) have at least one packing (18), preferably at least one structured packing.

8) The tray as claimed in claim 1, wherein said remixing means (12) have a network of tubes (19) connecting said chimneys (2) for the passage of said gas.

9) The tray as claimed in claim 1, wherein said means (13) for redistributing said gas have a plate (16) having a plurality of orifices, said orifices preferably being distributed evenly over said plate.

10) The tray as claimed in claim 1, wherein said casing (10) is arranged on the upper part of said chimneys (2) for the passage of said gas, said chimneys (2) in particular being covered by said casing (10) over a height less than three quarters of the height of said chimneys (2) for the passage of said gas.

11) The tray as claimed in claim 1, wherein said chimneys (2) for the passage of said gas are cylindrical.

12) The tray as claimed in claim 1, wherein at least two of said chimneys (2) for the passage of said gas have different diameters.

13) The tray as claimed in claim 1, wherein said casing (10) is covered by an inclined or triangular cap for transferring the liquid on both sides of the gas remixing casing (10).

14) A column for exchanging heat and/or material between a gas and a liquid, wherein said two fluids are brought into contact by way of a packing, characterized in that said column has at least one distributor tray (1) as claimed in claim 1 for distributing said fluids over said packing.

15) A method comprising using a column as claimed in claim 14 for a process for gas treatment, acid gas capturing, distillation, dehydration or air separation.
